(19) United States
(12) Patent Application Publication
(10) Pub. No.: US 2018/0319365 A1
(43) Pub. Date: Nov. 8, 2018

(54) OPTIMIZED ELECTRODE SHAPE FOR CAPACITIVE OCCUPANT CLASSIFICATION SYSTEM

(71) Applicant: IEE INTERNATIONAL ELECTRONICS & ENGINEERING S.A., Echternach (LU)

(72) Inventors: Caroline DERIEUX, Hettange-Grande (FR); Gianluca FAVALLI, Hautcharage (LU); Erik HOLZAPFEL, Prum (DE); Arnaud MEURENS, Aubange (BE)

(21) Appl. No.: 15/773,490

(22) PCT Filed: Nov. 4, 2016
(86) PCT No.: PCT/EP2016/076626

§ 371 Date: May 3, 2018

(30) Foreign Application Priority Data
Nov. 6, 2015 (LU) LU 92 865
Jan. 14, 2016 (LU) LU 92 946

(51) Int. Cl. B60R 22/48; B60N 2/00; B60R 22/26; B60N 2/26; B60R 22/10; G01V 3/08

(52) U.S. Cl. CPC B60R 22/48; B60N 2/002; B60R 22/26; B60R 2022/4808; B60R 22/105; G01V 3/08; B60N 2/26

(57) ABSTRACT

A capacitive sensor member of a seat occupant classification device for use in seats, in particular in vehicle seats. The capacitive sensor member includes at least one electrically conductive sense electrode that has an optimized shape for use in vehicle seats equipped with child restraint system anchorages. A capacitive seat occupant classification system is provided that includes the capacitive sensor member.

### TECHNICAL FIELD

The invention relates to a capacitive sensor member, a capacitive seat occupant classification device comprising such capacitive sensor member and a seat, in particular a vehicle seat, with such an installed seat occupant classification device.

### BACKGROUND OF THE INVENTION

Seat occupant detection and/or classification devices are nowadays widely used in vehicles, in particular in passenger cars, for providing a seat occupant signal for various appliances, for instance for the purpose of a seat belt reminder (SBR) system or an activation control for an auxiliary restraint system (ARS). Seat occupant detection and/or classification systems include seat occupant sensors that are known to exist in a number of variants, in particular based on capacitive sensing. An output signal of the seat occupant detection and/or classification system is usually transferred to an electronic control unit of the vehicle to serve, for instance, as a basis for a decision to deploy an air bag system to the vehicle seat.

A capacitive sensor or capacitive sensing device, called by some electric field sensor or proximity sensor, designates a sensor, which generates a signal responsive to the influence of what is being sensed (a person, a part of a person's body, a pet, an object, etc.) upon an electric field. A capacitive sensor generally comprises at least one antenna electrode, to which is applied an oscillating electric signal and which thereupon emits an electric field into a region of space proximate to the antenna electrode, while the sensor is operating. The sensor comprises at least one sense electrode at which the influence of an object or living being on the electric field is detected. In some (so-called “loading mode”) capacitive occupant sensors, the one or more antenna electrodes serve at the same time as sense electrodes. In this case, the measurement circuit determines the current flowing into the one or more antenna electrodes in response to an oscillating voltage being applied to them. The relationship of voltage to current yields the complex impedance between the one or more antenna electrodes and ground. In an alternative version of capacitive sensors (“coupling mode” capacitive sensors), the transmitting antenna electrode(s) and the sense electrode(s) are separate from one another. In this case, the measurement circuit determines the current or voltage that is induced in the sense electrode when the transmitting antenna electrode is operating.

The different capacitive sensing mechanisms are explained in the technical paper entitled “Electric Field Sensing for Graphical Interfaces” by J. R. Smith et al., published in IEEE Comput. Graph. Appl., 18(3):54-60, 1998. The paper describes the concept of electric field sensing as used for making non-contact three-dimensional position measurements, and more particularly for sensing the position of a human hand for purposes of providing three-dimensional positional inputs to a computer. Within the general concept of capacitive sensing, the author distinguishes between distinct mechanisms he refers to as “loading mode”, “shunt mode”, and “transmit mode” which correspond to various possible electric current pathways. In the “loading mode”, an oscillating voltage signal is applied to a transmit electrode, which builds up an oscillating electric field to ground. The object to be sensed modifies the capacitance between the transmit electrode and ground. In the “shunt mode”, an oscillating voltage signal is applied to the transmit electrode, building up an electric field to a receive electrode, and the displacement current induced at the receive electrode is measured, whereby the displacement current may be modified by the body being sensed. In the “transmit mode”, the transmit electrode is put in contact with the user's body, which then becomes a transmitter relative to a receiver, either by direct electrical connection or via capacitive coupling. “Shunt mode” is alternatively referred to as the above-mentioned “coupling mode”.

Capacitive occupant sensing systems have been proposed in great variety, e.g. for controlling the deployment of one or more airbags, such as e.g. a driver airbag, a passenger airbag and/or a side airbag. U.S. Pat. No. 6,161,070, to Jinno et al., relates to a passenger detection system including a single antenna electrode mounted on a surface of a passenger seat in an automobile. An oscillator applies on oscillating voltage signal to the antenna electrode, whereby a minute electric field is produced around the antenna electrode. Jinno proposes detecting the presence or absence of a passenger in the seat based on the amplitude and the phase of the current flowing to the antenna electrode.

U.S. Pat. No. 6,392,542, to Stanley, teaches an electric field sensor comprising an electrode mountable within a seat and operatively coupled to a sensing circuit, which applies to the electrode an oscillating or pulsed signal having a frequency “at most weakly responsive” to wetness of the seat. Stanley proposes to measure phase and amplitude of the current flowing to the electrode to detect an occupied or an empty seat and to compensate for seat wetness.

Others had the idea of using the heating element of a seat heater as an antenna electrode of a capacitive occupancy sensing system. International application WO 92/17344 A1 discloses an electrically heated vehicle seat with a conductor, which can be heated by the passage of electrical current, located in the seating surface, wherein the conductor also forms one electrode of a two-electrode seat occupancy sensor.

International application WO 95/13204 discloses a similar system, in which the oscillation frequency of an oscillator connected to the heating element is measured to derive the occupancy state of the vehicle seat. More elaborate combinations of a seat heater and a capacitive sensor are disclosed, for instance, in U.S. Pat. No. 7,521,940, US 2009/0295199 and U.S. Pat. No. 6,703,845.

Capacitive antenna electrodes are generally designed in order to cover substantially the entire seating surface of the vehicle seat. This ensures that a passenger may be reliably detected even if the passenger is sitting in an unnatural way on the seat, e.g. on the front-most position of the vehicle seat.

The capacitive sensing system should be able to distinguish an empty seat or a seat equipped with a child restraint system (CRS), from a person directly sitting on the seat.

A reliable capability of distinguishing between potential seat occupant classes is essential for fulfilling high safety requirements. Compared to vehicle seat classification systems conducting mechanical load-based resistive measurements that are also known in the art, a capacitive measurement has the advantages of a simpler wiring and a stable and reproducible measurement over an entire temperature range as specified in common vehicle requirements.

Vehicle seat occupant classification systems that are based on mechanical load sensors can operate well in a presence of a CRS such as the wide-spread ISOFIX system or others. These objects are not putting a high weight on the seat. However, misclassification could happen with heavy CRS if a high belting force was applied.

A seat, in particular a vehicle seat occupant classification device based on capacitive sensing measures a physical quantity, for instance an electric current through a capacitive sensor member or a complex impedance or admittance of the capacitive sensor member, wherein the physical quantity is representative of an electric field between at least one sense electrode of the capacitive sensor member and a vehicle body.

The at least one sense electrode may be positioned on or inside the vehicle seat. A seat occupant or an object which is placed on the vehicle seat will modify the electric field of the sense electrode, resulting in a change of the measured physical quantity.

A problem concerning a capacitive system sensing between a sense electrode and vehicle ground might occur as follows:
without an installed CRS, a seat equipped with a CRS is sensed as low capacity, whereas a person sitting directly on seat is sensed as high capacitance;
with an installed CRS, the system senses a high capacitance, which may create a misclassification.

In this way, vehicle seat occupant classification systems based on capacitive sensing are subject to being misled in the case of vehicle-grounded objects being placed on a vehicle seat, for instance a seat of a CRS, such as ISOFIX, that in an installed state is grounded by mechanically connecting the CRS to anchorages that are fixedly attached to the vehicle body. Child restraint systems are equipped with metallic clips that are configured for quick fixation at the anchorages. The metallic clips are part of a metal frame arranged inside the CRS. This metal frame could come close to the sense electrode within a few millimeters. Depending on the proximity of the grounded CRS metal frame to the at least one sense electrode of the capacitive sensor member, the sensed physical quantity might be large enough to cause the vehicle seat occupant classification system to classify a CRS electrically connected to vehicle ground as a “person sitting directly on seat”.

In such cases, an ability of the vehicle seat occupant classification system to correctly classify a seat occupant might be affected. In this way, any object that is connected to vehicle ground may lead to a misclassification by the vehicle seat occupant classification system due to a relatively small distance between the capacitive sensor member and the grounded object.

A necessity of additionally employing mechanical load sensors to prevent such misclassification increases an effort in hardware, complexity and costs for a vehicle seat occupation classification system of desired discrimination performance.

### SUMMARY

It is therefore an object of the present invention to provide a seat occupant classification system, in particular a vehicle seat occupant classification system, that is able to reliably and correctly classify a seat occupant without the above described shortcomings, and which particularly enables a correct classification of CRS installed with ISOFIX system.

In one aspect of the present invention, the object is achieved by a capacitive sensor member of a seat occupant classification device for use in seats, in particular in vehicle seats. The capacitive sensor member comprises at least one electrically conductive sense electrode that has an optimized shape for use in vehicle seats equipped with child restraint system anchorages.

In a preferred embodiment, the at least one sense electrode is electrically connectable to a capacitance measurement circuit that is configured for determining a physical quantity which is indicative of a capacitance of the sense electrode with regard to a reference potential. The term “capacitance”, as used in this application, shall in particular be understood to encompass an absolute capacitance value as well as a capacitance value that is referenced to an arbitrary zero point of capacitance. The term “being configured to”, as used in this application, shall in particular be understood as being especially programmed, laid out, furnished or arranged.

Preferably, the reference potential is a ground potential and in particular a vehicle ground potential.

The at least one sense electrode is designed to have at least a substantially rectangular main portion having a width such that the sense electrode in an operational state is positionable with a minimum gap of 20 mm to virtual planes that are arrangeable perpendicular to a floor the seat is erected on, and are each alignable with one of inner surfaces of arms of a metal frame of the child restraint system that are facing each other.

The phrase “substantially rectangular”, as used in this application, shall in particular be understood such that a relative difference between an area of the shape of the main portion and an area of a smallest rectangle that is able to overlap the main portion is less than 20%, preferably less than 10%, and, most preferably, less than 5% of an area of the main portion. In particular, the substantially rectangular shape of the main portion may have rounded corners.

In this way, a relative weight of a change of the measured physical quantity caused by a human sitting directly on the seat can be increased, and a relative weight of a change of the measured physical quantity caused by the metal frame of the CRS can be lowered. This can support preventing misclassifications of seat occupants. A gap of 20 mm has turned out to be at least close to an optimum trade-off between the two relative weights. If the gap was much wider, a change of the measured physical quantity caused by a human sitting directly on the seat would become smaller. If the gap was much smaller, a change of the measured physical quantity caused by the metal frame of the CRS would become disadvantageously large.

It will be readily appreciated by those of skills in the art that a gap size that is close to 20 mm would also be beneficial. Therefore, deviations from the gap size of 5 mm to either side shall also be understood as being in accordance with the invention.

In another preferred embodiment, the at least one sense electrode has at least one extension portion that in the operational state is positionable to overlap, in a direction perpendicular to the floor, at least one opening in the metal frame of the CRS being connected to the vehicle anchorages.

The term “to overlap in a direction”, as used in this application, shall in particular be understood as to overlap as seen in the direction.

By that, the relative weight of the change of the measured physical quantity caused by the human sitting directly on the seat can further be increased, and the relative weight of the change of the measured physical quantity caused by the metal frame of the CRS can further be lowered. This can further support preventing misclassifications of seat occupants.

In yet another preferred embodiment, the at least one sense electrode comprises two extension portions that in the operational state are each positionable to overlap, in the direction perpendicular to the vehicle floor, at least one opening in the metal frame of the child restraint system being connected to the vehicle anchorages, wherein the two extension portions are arranged in a spaced relationship to each other and extend from a front end of the main portion.

The term “front edge of the main portion”, as used in this application, shall in particular be understood as an edge that is proximal to a front edge of the seat.

As an effect of the openings of the CRS is smaller than the effect of the grounded metal frame, the relative weight of the change of the measured physical quantity caused by the human sitting directly on the seat can beneficially be increased further.

Preferably, the extension portion is or the extension portions are integrally formed with the main portion of the at least one sense electrode.

In some embodiments, the main portion of the at least one sense electrode in an operational state is positionable to overlap, in the direction perpendicular to the floor, in particular the vehicle floor, at least 30%, preferably more than 35%, and, most preferably, more than 40% of a length of a seat base cushion of the seat as measured in a direction that is arranged in parallel with arms of the child restraint system, without overlapping the metal frame of the child restraint system in the direction perpendicular to the floor.

In this way, the relative weight of the change of the measured physical quantity caused by a human sitting directly on the seat can advantageously be increased still further.

Preferably, the at least one sense electrode is made from thin metal foil, which can allow for flexible design and easy manufacturing.

In another aspect of the invention, a capacitive seat occupant classification system is provided. The capacitive seat occupant classification system includes
at least one embodiment of the capacitive sensor member as disclosed beforehand,
a capacitance measurement circuit that is configured for generating a time-varying output signal, for providing the time-varying output signal to the at least one capacitive sensor member and for determining a physical quantity which is indicative of a capacitance of the sense electrode with regard to a reference potential, and
an evaluation unit that is configured for generating an output signal that is indicative of at least one out of detecting and of classifying a seat occupant, the output signal being based on the determined physical quantity and a comparison of the determined physical quantity to at least one predetermined value for the determined physical quantity.

Capacitance measurement circuits for determining the capacitance of the capacitive sensor member are known in the art in a large number of variations and shall therefore not described in more detail herein. Any capacitance measurement circuit that appears to be suitable to the person skilled in the art may be employed.

In this way, a capacitive seat occupant classification system with an improved performance regarding reliable and correct classification of potential seat occupants, in particular an installed CRS can be provided.

Preferably, the output signal of the evaluation unit may be intended to be transferred to an electronic control unit of the vehicle to serve, for instance, as a basis for a decision to deploy an air bag system to the vehicle seat.

In yet another aspect of the invention, as seat, in particular a vehicle seat, with an installed capacitive seat occupant classification system as disclosed beforehand is provided. The seat comprises a seat base that is configured for taking up a seat base cushion. The seat base and the seat base cushion are provided for supporting a bottom of a seat occupant. The seat further includes a backrest that is configured for taking up a backrest cushion provided for supporting a lumbar and back region of the seat occupant. Moreover, the seat is equipped with at least a pair of anchorages configured for mechanically engaging with corresponding fixation members of a child restraint system. The at least one sense electrode is arranged at the A surface of the seat base cushion.

In this way, a seat, in particular a vehicle seat, with a reliable and correct classification of potential seat occupants, in particular of an installed CRS can be provided.

These and other aspects of the invention will be apparent from and elucidated with reference to the embodiments described hereinafter.

### BRIEF DESCRIPTION OF THE DRAWINGS

Further details and advantages of the present invention will be apparent from the following detailed description of not limiting embodiments with reference to the attached drawing, wherein:

FIG. 1 schematically shows a top view of a seating surface (A surface) of a vehicle seat;

FIG. 2 schematically illustrates the vehicle seat pursuant to FIG. 1 with a sketch of a dummy CRS capacitive footprint;

FIG. 3 schematically shows a top view of the vehicle seat pursuant to FIG. 1 and a capacitive footprint of a MaxiCosi® EasyFix child restraint system;

FIG. 4 schematically shows a top view of the vehicle seat pursuant to FIG. 1 and a capacitive footprint of a BeSafe® iZi Kid child restraint system;

FIG. 5 schematically shows a top view of the vehicle seat pursuant to FIG. 1 and superposed capacitive footprints of the MaxiCosi® EasyFix and the BeSafe® iZi Kid child restraint systems and a sense electrode of a capacitive sensor member in accordance with the invention; and

FIG. 6 schematically shows a top view of the vehicle seat and superposed capacitive footprints of the MaxiCosi® EasyFix and the BeSafe® iZi Kid child restraint systems pursuant to FIG. 5 and an alternative sense electrode of a capacitive sensor member in accordance with the invention.

### DESCRIPTION OF PREFERRED EMBODIMENTS

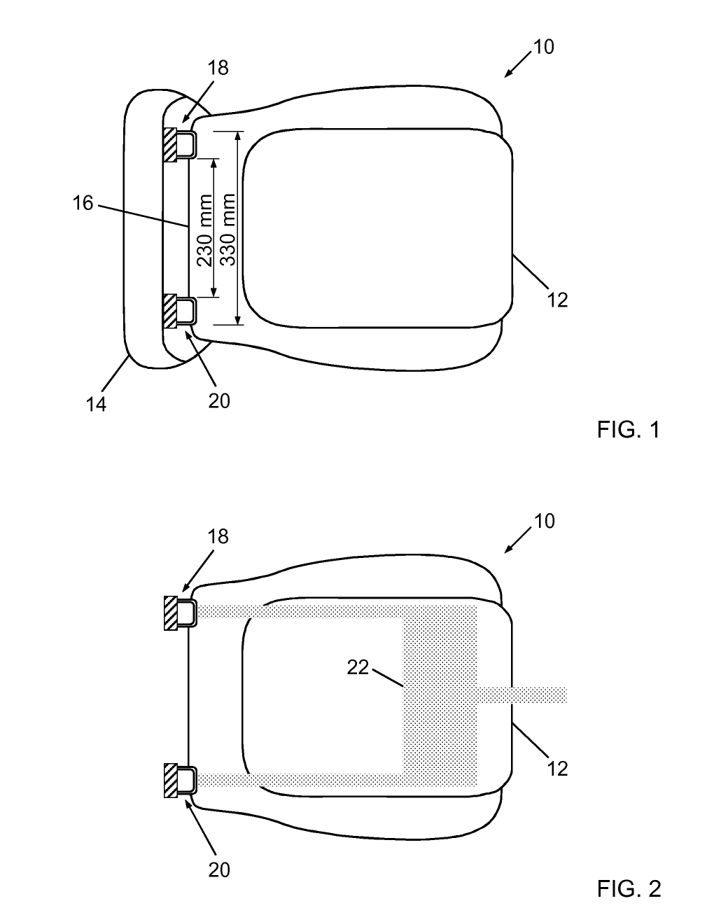

FIG. 1 schematically shows a top view of a seating surface (A surface) of a seat base cushion 12 of a seat 10. The seat 10 is formed in particular as a vehicle seat and, more specific, as a passenger car seat.

The seat 10 comprises a seat structure (not shown) for erecting the seat 10 on a passenger cabin floor of the vehicle. A seat base is configured for taking up a seat base cushion 12. The seat base and the seat base cushion 12 are provided for supporting a bottom of a human seat occupant. The seat 10 further includes a backrest 14 configured for taking up a backrest cushion provided for supporting a lumbar and back region of the seat occupant. The backrest 14, which is only shown in FIG. 1 for clarity reasons, is arranged at a rear edge 16 of the seat base cushion 12 shown on the left-hand side of FIG. 1.

The vehicle seat is furnished with a pair of anchorages 18, 20 that are fixedly attached at locations arranged between the rear edge 16 of the seat base cushion 12 and a bottom edge of the backrest 14. The anchorages 18, 20 are designed as mounting brackets made from 6 mm diameter round bar steel and are compatible with the “ISOFIX” standard ISO 13216. The anchorages 18, 20 are spaced from each other at a distance between 230 mm and 330 mm. The anchorages 18, 20 are configured for mechanically engaging with corresponding fixation members of a child restraint system (CRS).

When an ISOFIX CRS is installed at the vehicle seat, its inner metal frame comes close to the seat A-surface. By analogy to pressure distribution, a proximity of grounded metal parts induces a “capacitive footprint” on the A-surface. FIG. 2 schematically illustrates the seat 10 pursuant to FIG. 1 with a sketch of a dummy CRS capacitive footprint 22.

It is important to note that the capacitive footprint 22 is mainly due to metal bars of the inner metal frame, which can be grounded from outside. All metal bars located inside the CRS and electrically insulated from the outside should not be considered.

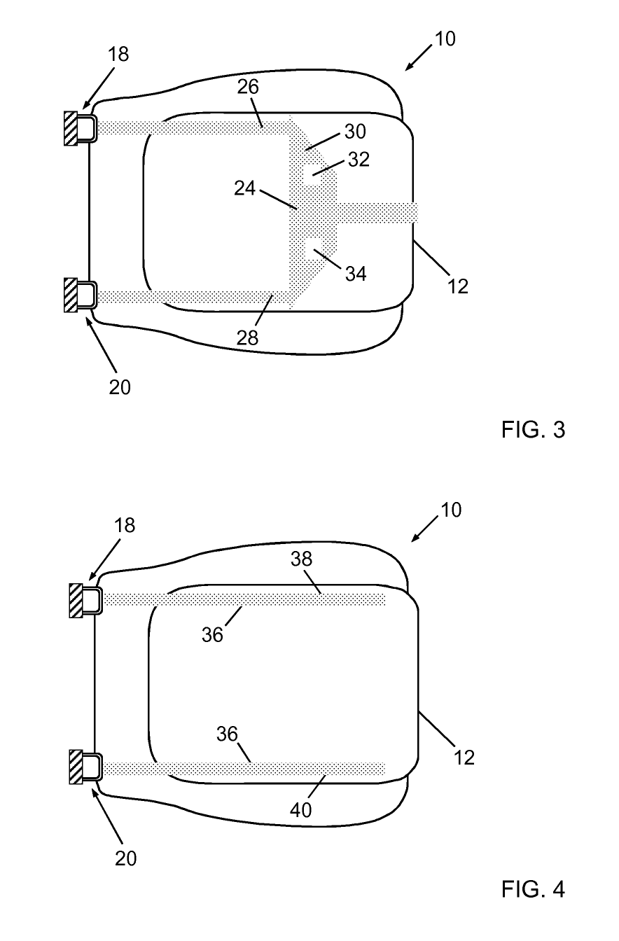

FIG. 3 schematically shows a top view of the seat 10 pursuant to FIG. 1 and a capacitive footprint 24 of a MaxiCosi® EasyFix child restraint system. The metal frame of the MaxiCosi® EasyFix child restraint system comprises two metal beam-shaped arms 26, 28 that are mechanically and electrically connected to the vehicle seat anchorages 18, 20, and a traverse member 30 having two square-shaped openings 32, 34.

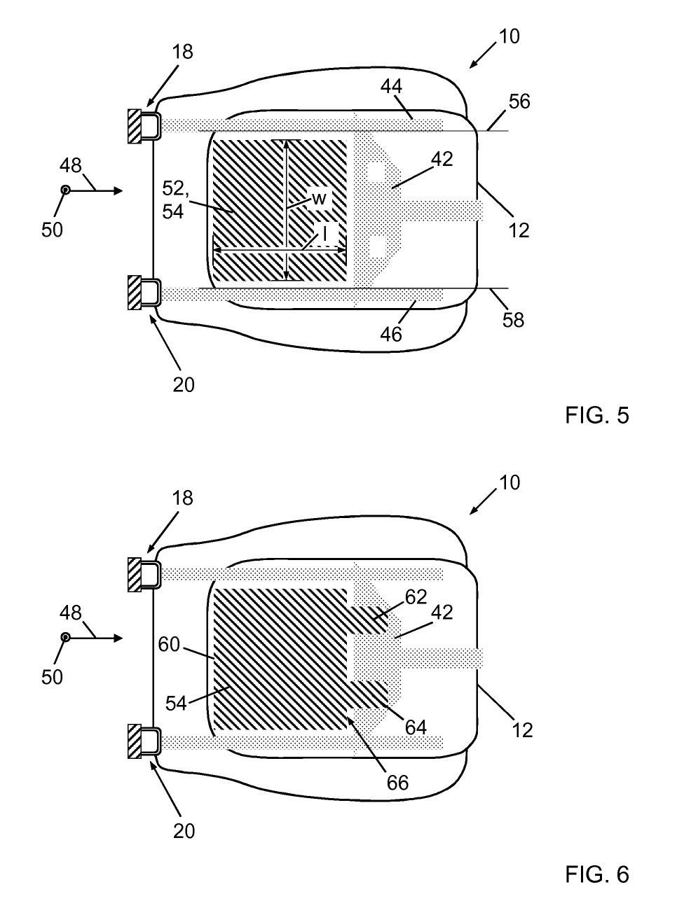

FIG. 4 schematically shows a top view of the seat 10 pursuant to FIG. 1 and a capacitive footprint 36 of a BeSafe® iZi Kid child restraint system. The metal frame of the MaxiCosi® EasyFix child restraint system comprises just two metal beam-shaped arms 38, 40 that are mechanically and electrically connected to the vehicle seat anchorages 18, 20. FIG. 5 schematically shows a top view of the seat 10 pursuant to FIG. 1 and superposed capacitive footprints 42 of the MaxiCosi® EasyFix and the BeSafe® iZi Kid child restraint systems pursuant to FIGS. 4 and 5.

The seat 10 shown in FIG. 5 further includes an installed seat occupant classification device in accordance with the invention. The seat occupant classification device comprises a capacitive sensor member with an electrically conductive sense electrode 52 that has an optimized shape for use in vehicle seats equipped with CRS anchorages 18, 20. The sense electrode 52 is arranged at the A surface of the seat base cushion 12.

In order to accomplish good classification properties between human seat occupants arranged directly on the vehicle seat and an ISOFIX CRS, two guidelines have been considered in the design of the sense electrode 52 of the capacitive sensor member:
on the one hand, the sense electrode 52 should be as large as possible in order to maximize a signal caused by humans sitting directly on the vehicle seat;
on the other hand, the sense electrode 52 should be kept away from the CRS capacitive foot print 42 in order to minimize a CRS activation.

The sense electrode 52 of the capacitive sensor member in accordance with the invention is electrically connectable to a capacitance measurement circuit (not shown) that is configured for determining a physical quantity, namely an electric current through the sense electrode 52, which is indicative of a capacitance of the sense electrode 52 with regard to a reference potential that is given by the electric potential of the vehicle chassis.

The capacitance measurement circuit is configured for generating a time-varying output signal, namely a sinusoidal voltage, and for providing the time-varying output signal to the capacitive sensor member. Further, the capacitance measurement circuit is configured for determining the electric current through the sense electrode 52.

An output signal of the capacitance measurement circuit can be transferred to an evaluation unit (not shown) of the capacitive seat occupant classification system. The evaluation unit is configured for generating an output signal that is indicative of classifying a seat occupant. The output signal is based on the determined electric current through the sense electrode and a comparison of the determined electric current to predetermined values for the electric current. As this part does not belong to the core of the invention and is well known in the art, it is not necessary to describe it in more detail herein.

The sense electrode 52 is designed to have a substantially rectangular main portion 54 having a width w of about 220 mm, so that the sense electrode 52, as in the operational state shown in FIG. 5, is positionable with a minimum gap of 20 mm, and is actually positioned with a gap of about 22 mm, to virtual planes 56, 58 that are arrangeable perpendicular to the passenger cabin floor that the seat 10 is erected on, and are each aligned with one of inner surfaces of the arms 44,46 of the metal frame of the CRS that are facing each other. In FIG. 5, the virtual planes 56, 58 show as straight lines.

As will be appreciated by those skilled in the art, the substantially rectangular shaped main portion 54 of the sense electrode 52 may have rounded edges to prevent increased values for an electric field strength at corners of the sense electrode 52.

The sense electrode 52 is made from thin aluminum foil or, alternatively, from an aluminized plastic material such as polyethylene terephthalate (PET), with a length l of about 135 mm, as measured in a direction 48 that is arranged in parallel with metal arms 44, 46 of the child restraint systems, and thus overlaps more than 40% of a length of the seat base cushion 12 of the vehicle seat. In a direction 50 perpendicular to the floor, the metal frame of the child restraint system is not overlapped at all by the sense electrode 52. The length l of the sense electrode 52 is adapted such that the main portion 54 covers substantially an entire back region of the seating surface without extending under the traverse member 30 of the MaxiCosi® EasyFix CRS.

FIG. 6 schematically shows a top view of the seat 10 and superposed capacitive footprints 42 of the MaxiCosi® EasyFix and the BeSafe® iZi Kid child restraint systems pursuant to FIG. 5 and an alternative sense electrode 60 of a capacitive sensor member in accordance with the invention. For the sake of brevity, only differences to the embodiment disclosed beforehand will be described.

The alternative sense electrode 60 comprises two extension portions 62, 64 of about 30×75 mm size with rounded edges. The overall length of the sense electrode 60 in the region of the extension portions is thus about 210 mm. The extension portions 62, 64 and the main portion 54 of the sense electrode 60 are integrally formed. In the operational state shown in FIG. 6, each one of the extension portions 62, 64 is positioned to overlap, in the direction 50 perpendicular to the vehicle floor, one of the two openings 32, 34 in the metal frame of the CRS being directly connected to the vehicle anchorages 18, 20. The two extension portions 62, 64 are arranged in a spaced relationship to each other and extend from a front end 66 of the main portion 54 of the sense electrode 60.

The alternative sense electrode 60 is especially beneficial for adding robustness for classifying human beings sitting on the seat 10 in a position that is front-shifted relative to a nominal sitting position.

While the invention has been illustrated and described in detail in the drawings and foregoing description, such illustration and description are to be considered illustrative or exemplary and not restrictive; the invention is not limited to the disclosed embodiments.

Other variations to be disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting scope.

1. A capacitive sensor member of a seat occupant classification device for use in vehicle seats, the capacitive sensor member comprising at least one electrically conductive sense electrode that has an optimized shape for use in vehicle seats equipped with child restraint system anchorages.

2. The capacitive sensor member as claimed in claim 1, wherein
the at least one sense electrode is electrically connectable to a capacitance measurement circuit that is configured for determining a physical quantity which is indicative of a capacitance of the at least one sense electrode with regard to a reference potential,
and wherein
the at least one sense electrode is designed to have at least a substantially rectangular main portion having a width (w) such that the at least one sense electrode in an operational state is positionable with a minimum gap of 20 mm to virtual planes that are arrangeable perpendicular to a floor on which the seat is erected, and are each alignable with one of inner surfaces of arms of a metal frame of the child restraint system that are facing each other.

3. The capacitive sensor member as claimed in claim 1, wherein the at least one sense electrode has at least one extension portion that in the operational state is positionable to overlap, in a direction perpendicular to the floor, at least one opening in the metal frame of the child restraint system being connected to the vehicle anchorages.

4. The capacitive sensor member as claimed in claim 1, wherein the at least one sense electrode comprises two extension portions that in the operational state are each positionable to overlap, in the direction perpendicular to the vehicle floor, at least one opening in the metal frame of the child restraint system being connected to the vehicle anchorages, wherein the two extension portions are arranged in a spaced relationship to each other and extend from a front end of the main portion.

5. The capacitive sensor member as claimed in claim 1, wherein the main portion of the at least one sense electrode in an operational state is positionable to overlap, in the direction perpendicular to the floor, at least 30% of a length of a seat base cushion of the seat as measured in a direction that is arranged in parallel with arms of the child restraint system without overlapping the metal frame of the child restraint system in the direction perpendicular to the floor.

6. The capacitive sensor member as claimed in claim 1, wherein the at least one sense electrode is made from thin metal foil.

7. A capacitive seat occupant classification system, comprising
at least one capacitive sensor member as claimed in claim 1,
a capacitance measurement circuit that is configured for generating a time-varying output signal, for providing the time-varying output signal to the at least one capacitive sensor member and for determining a physical quantity which is indicative of a capacitance of the sense electrode with regard to a reference potential, and
an evaluation unit that is configured for generating an output signal that is indicative of at least one out of detecting and of classifying a seat occupant, the output signal being based on the determined physical quantity and a comparison of the determined physical quantity to at least one predetermined value for the determined physical quantity.

8. A vehicle seat, with an installed seat occupant classification device as claimed in claim 7, the seat comprising
a seat base configured for taking up a seat base cushion, the seat base and the seat base cushion being provided for supporting a bottom of a seat occupant,
a backrest configured for taking up a backrest cushion provided for supporting a lumbar and back region of the seat occupant, and
at least a pair of anchorages configured for mechanically engaging with corresponding fixation members of a child restraint system,
wherein the at least one sense electrode is arranged at an A surface of the seat base cushion.

9. (canceled)

10. A method of occupant seat classification for an occupant sitting in the vehicle seat claimed in claim 8, comprising the steps of: determining the physical quantity using the capacitance measurement circuit and, based on the physical quantity, generating the output signal indicative of the detection or classification of a seat occupant using the evaluation unit.
